(19) United States
(12) Patent Application Publication
(10) Pub. No.: US 2009/0199186 A1
(43) Pub. Date: Aug. 6, 2009

(54) Method for controlling a batch process recipe

(76) Inventor: Harald Rosskopf, Pfinztal-Woschbach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/321,524

(22) Filed: Jan. 22, 2009

(30) Foreign Application Priority Data
Jan. 22, 2008 (EP) 08001137.2

(51) Int. Cl. G06F 9/46

(52) U.S. Cl. 718/100

(57) ABSTRACT

A method for controlling a batch process recipe, having a first recipe phase and a recipe phase step enabling condition is described, wherein a function module assigned to the first recipe phase is executed by a programmable controller and wherein a first setpoint value and a first actual value are stored in the first recipe phase. Measures are proposed whereby in the context of recipe creation particular functionalities are implemented graphically and therefore visibly for the user without it being necessary to adapt a function module running in the programmable controller.

### CROSS REFERENCE TO RELATED APPLICATIONS

This application claims priority of European Patent Office application No. 08001137.2 EP filed Jan. 22, 2008, which is incorporated by reference herein in its entirety.

### FIELD OF INVENTION

The invention relates to a method for controlling a batch process recipe, comprising a first recipe phase and a recipe phase step enabling condition, wherein a function module assigned to the first recipe phase is executed by means of a programmable controller and wherein a first setpoint value and a first actual value are stored in the first recipe phase. The invention also relates to a computer program which, when run on a programming unit operatively connected to a programmable controller, controls a batch process recipe, and, in addition, a programming unit incorporating a computer program of this kind.

### BACKGROUND OF INVENTION

A computer program for implementing a method is known from the Siemens Catalog “ST PCS 7—March 2007”, SIMATIC PCS 7, page 4/7 and Section 6. On a display unit, a user graphically creates a recipe for controlling a batch process by means of a so-called BATCH software package that can be run on a programming unit. This recipe has a plurality of recipe phases which are executed sequentially by the programming unit from a start point onward, wherein for each recipe phase a programmable controller connected online to the programming unit correspondingly executes a function module assigned to said recipe phase.

In the context of a “dosing” recipe phase it may happen that during a dosing operation the programmable controller only doses eighty units of an article, even though a dosing quantity of e.g. one hundred units is specified for this recipe phase in the programming unit. The dosed quantity of eighty units (actual value) is communicated by the programmable controller's function module to the recipe phase in the programming unit in which this actual value is stored as the “already dosed quantity”. In this case another dosing operation is required for which the recipe phase communicates twenty units to the programmable controller as the setpoint quantity which the recipe phase determines by taking the difference between the specified dosing quantity of a hundred and the already dosed quantity of eighty units. Assuming that during the subsequent dosing operation the programmable controller only doses fifteen units (new actual value), this will result in disturbances in the “dosing” recipe phase unless appropriate action is taken, as the new actual value of fifteen units communicated to the programming unit is again stored in the programming unit as the “already dosed quantity”, which means that the recipe phase determines from the specified dosing quantity of a hundred units and the “new” already dosed quantity of fifteen (instead of eighty-five) units a new setpoint value of eighty-five (instead of five) units and supplies this to the programmable controller for another dosing operation. In order to prevent such a problem, the function module is usually “adapted” in the programmable controller. This means that the function module communicates to the recipe phase an actual value which the function module calculates by adding together the actual values of all the dosing operations performed. The disadvantage of this is that the function module can no longer be used universally, but only for this specific application. In addition, a module of this kind must be appropriately designed using suitable engineering software that can be run on an engineering system and finally implemented in the programmable controller.

### SUMMARY OF INVENTION

An object of the present invention is to improve a method of the type mentioned in the introduction. A computer program shall also be specified which, when run on a programming unit operatively connected to a programmable controller, controls a batch process recipe and is suitable for implementing such a method. In addition, a suitable programming unit incorporating a computer program of this kind shall be created.

The object is achieved with a method, a computer program and a programming unit according to the claims.

It is advantageous that, as part of recipe creation, particular functionalities can be implemented graphically and therefore visibly for a user, without it being necessary to adapt a function module running in the programmable controller.

In one embodiment of the invention it is provided that the second recipe phase is a summing phase with which the actual value is determined by adding together actual values communicated by the programmable controller. A summing phase of this kind ensures that the already dosed quantity is always made available to a “dosing” recipe phase that is to be repeatedly executed as an actual value.

In another embodiment of the invention, the second recipe phase is an incrementing phase with which the actual value is determined from the number of recipe phases completed. This makes it possible to implement a loop counter which, e.g. in the context of a dyeing process, records the number of dyeing passes, causing the dyeing process to be terminated after a specified number of passes in order to avoid damaging the material to be dyed.

Further advantageous embodiments to the invention will emerge from the other sub-claims.

### BRIEF DESCRIPTION OF THE DRAWINGS

The invention, its embodiments and advantages will now be explained in greater detail with reference to the accompanying drawings in which exemplary embodiments of the invention are illustrated.

FIG. 1 shows a function chart of a batch process,

FIGS. 2 and 3 show data flows for a dosing and a dyeing process.

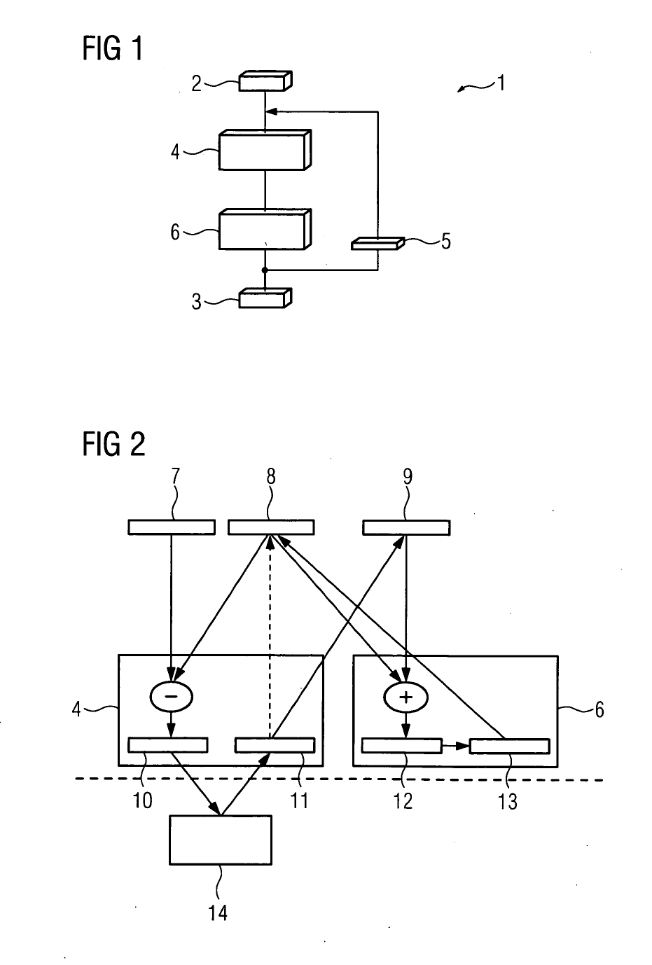

Identical parts shown in FIGS. 1 to 3 are provided with the same reference characters.

### DETAILED DESCRIPTION OF INVENTION

Denoted by 1 in FIG. 1 is a function chart of a dosing process, said function chart 1 comprising a start and an end step 2, 3, a first recipe phase in the form of a dosing phase 4, a step enabling condition 5 and, downstream of the dosing phase 4, a second recipe phase in the form of a summing phase 6. A user creates the function chart 1 by means of a so-called per se known SFC (sequential function chart) editor which can be run on a programming unit (not shown here). Said programming unit, which may also be designed to create a function module assigned to the dosing phase 4 using a suitable engineering software package, has a display unit on which the function chart 1 can be displayed. During batch process control, a suitable program of the programming unit sequentially executes the function chart 1, a programmable controller operatively connected to the programming unit correspondingly executing the function module assigned to the dosing phase 4 and the dosing phase 4 communicating a setpoint value to the function module and the function module communicating an actual value to the dosing phase 4. In conjunction with other suitable hardware and software, the function module controls the dosing operation in a technical installation, e.g. substance dosing in the pharmaceutical industry for drug production. In contrast to the dosing phase 4, for the summing phase 6 no corresponding function module is provided on the programmable controller. Said summing phase 6 is used solely to influence an actual value recorded by the function module corresponding to the dosing phase 6.

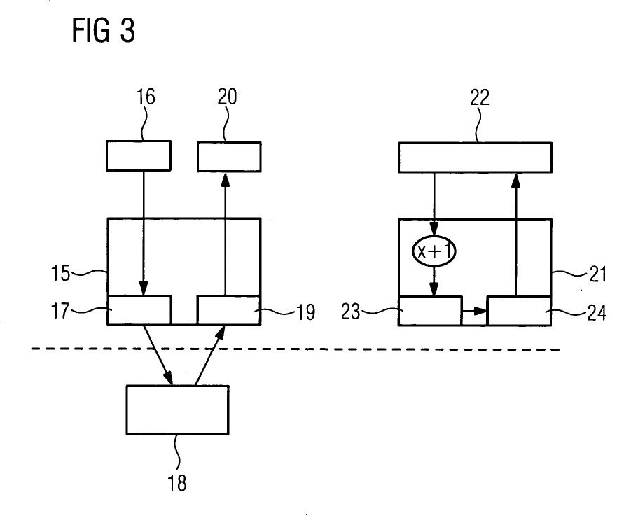

For clarification, reference is made in this connection to FIG. 2 which shows the data flow during a dosing operation between a programming unit and a programmable controller operatively connected to said programming unit. Only the parts necessary for clarification of the invention are shown, the separation between the parts to be processed in the programming unit and the parts to be processed in the programmable controller being indicated by a dashed line.

It is assumed that a user-specified dosing quantity 7, a quantity 8 already dosed in the course of dosing operations whose initial value is 0, as well as an actual quantity 9 which is determined during a dosing operation, are stored in a parameter list or more specifically in programming unit memory cells provided for that purpose. It is also assumed that a hundred units of a substance are to be dosed, which means that the value one hundred is entered as the dosing quantity 7 and that the step enabling condition 5 allows the first and the second recipe phase 4, 6 to be repeated until a hundred units of that substance have been dosed. As usual, two memory cells or two groups of memory cells are provided for storing a setpoint and an actual value for each phase. In this exemplary embodiment, for the dosing phase 4 a setpoint value is denoted by 10 and an actual value by 11, for the summing phase 6 a setpoint value is denoted by 12 and an actual value by 13. After activation of the starting step 2 (FIG. 1), during a first dosing operation the dosing phase 4 determines the setpoint value 12 by subtracting the already dosed quantity 8 from the dosing quantity 7. The already dosed quantity 8 is after the starting step 2 equal to zero, which means that in this example the value of the difference and therefore the setpoint value 12 is one hundred. This value of one hundred is fed by the dosing phase 4 to a programmable controller function module 14 assigned to said dosing phase 4, which function module begins to dose one hundred units of the substance during the current dosing operation in conjunction with other suitable hardware and software. It can now happen that during this dosing operation, because of other dependence criteria, e.g. pH value or substance viscosity attained, only twenty units of the substance can be dosed. In this case further dosing operations are required—as will be explained in more detail below. The function module 14 in the programmable controller feeds the dosed quantity of twenty units to the dosing phase 4, the dosed quantity being stored as the actual value 11 in said dosing phase 4 and the programming unit storing this actual value 11 in the parameter list as the actual quantity 9 of the dosing operation currently being performed and not—as known from the prior art and shown in the drawing as a dotted line—as the already dosed quantity 8.

The summing phase 6 following the dosing phase 4 influences the actual value 11 or rather the actual quantity 9 by adding to said actual quantity 9 the already dosed quantity 8 stored in the parameter list and storing the result as the setpoint value 12. In this exemplary embodiment—as stated—the actual quantity 9 is twenty and the already dosed quantity zero, so that the setpoint value 12 is twenty units. This setpoint value 12 is not communicated to a function module in the programmable controller, but stored directly as the actual value 13 in the summing phase. This actual value 13 is finally stored in the parameter list as the “new” already dosed quantity 8 of twenty units, thereby completing the first dosing operation. Because of the step enabling condition 5, another dosing operation is required and the dosing and downstream summing phase 4, 6 are repeated, as the already dosed quantity 8 (twenty units) is less than the dosing quantity 7 (one hundred units).

The subsequent dosing operation and any other dosing operations take place in the same manner until the already dosed quantity 8 corresponds to the dosing quantity 7 and the step enabling condition 5 therefore initiates no further dosing operation.

For the case that in a second dosing operation sixty, in a third fifteen and in a fourth five units are dosed by means of the programmable controller, values are obtained as shown in the following table:

| Dosing | Already | Setpoint | Dosed by | Actual | Actual | Setpoint | Actual |
|---|---|---|---|---|---|---|---|
| quantity | dosed | value 10 of | programmable | value 11 of | quantity | value 12 of | value 13 of |
| 17 | quantity 8 | dosing phase 4 | controller | dosing phase 4 | 9 | summing phase 6 | summing phase 6 |
| 100 | 0 | 100 | 20 | 20 | 20 | 20 | 20 |
| 100 | 20 | 80 | 60 | 60 | 60 | 80 | 80 |
| 100 | 80 | 20 | 15 | 15 | 15 | 95 | 95 |
| 100 | 95 | 5 | 5 | 5 | 5 | 100 | 100 |

In the following it will be assumed that the first recipe phase 4 as shown in FIG. 1 is not a dosing phase but a dyeing phase and the second phase 6 is not a summing phase but an incrementing phase. Said incrementing phase records the number of dyeing passes, causing the dyeing process to be terminated after a predetermined number of dyeing passes to prevent damage to the material to be dyed. In this connection reference is made to FIG. 3 which shows the data flow of a dyeing operation. The separation between the parts to be processed in the programming unit and the parts to be processed in the programmable controller is again indicated by a dashed line, here too two memory cells or two groups of memory cells for storing a setpoint value and an actual value being provided in the programming unit for each phase. A setpoint color 16 is specified or more specifically communicated to a dyeing phase 15 from a parameter list which stores the dyeing phase 15 as setpoint value 17 in the memory cell provided for that purpose. Said setpoint value 17 is fed by the dyeing phase 15 to a programmable controller function module 18 corresponding to that phase, which function module—as stated—controls the dyeing operation in conjunction with other suitable hardware and software, the current color of the material being determined and this being communicated to the dyeing phase 15. The current color of the dyeing operation is stored by the dyeing phase 15 as the actual value 19 which is stored in the parameter list as the current actual color 20. It can happen that, because of the material used, only five dyeing passes are possible. More than five dyeing passes would overstress the material and reduce the quality of the end product. The step enabling condition 5 is therefore set such that in addition to comparing the setpoint/actual value in respect of the color (comparison of setpoint color with actual color) it also checks the number of dyeing passes. For the case that the actual color corresponds to the setpoint color or five dyeing passes have already been carried out, the step enabling condition 5 prevents any further dyeing pass and terminates the dyeing process. In order to record the number of dyeing passes, the dyeing phase 15 is followed by an incrementing phase 21 which supplies a count 22 to the parameter list. This count is increased by one after each dyeing operation and stored in the dyeing phase 21 as setpoint value 23. In the dyeing phase 21, no function module corresponding to this phase is provided in the programmable controller for influencing the actual value, instead of which this setpoint value 23 is adopted as the actual value 24 and stored in the parameter list as the new count. For the case that the count 23 attains a value of five, because of the step enabling condition 5 the dyeing process is terminated or rather aborted.

1.-9. (canceled)

10. A method for controlling a batch process recipe having a first recipe phase and a recipe phase step enabling condition, comprising:
executing a function module assigned to the first recipe phase by a programmable controller;
storing a first setpoint value and a first actual value during the first recipe phase;
providing a second setpoint value and a second actual value in a second recipe phase, the second recipe phase following the first recipe phase;
repeating the first and the second recipe phases in accordance with the recipe phase step enabling condition; and
adopting the second setpoint value as the second actual value during the second recipe phase.

11. The method as claimed in claim 10, wherein the second recipe phase is a summing phase.

12. The method as claimed in claim 10, wherein the second recipe phase is an incrementing phase.

13. A computer readable medium storing a computer program which, when run on a programming unit operatively connected to a programmable controller, controls a batch process recipe having a first recipe phase and a step enabling condition, comprising:
executing a function module assigned to the first recipe phase by the programmable controller;
storing a first setpoint value and a first actual value during the first recipe phase;
providing a second setpoint value and a second actual value in a second recipe phase, the second recipe phase following the first recipe phase;
repeating the first and the second recipe phases in accordance with the step enabling condition; and
adopting the second setpoint value as the second actual value during the second recipe phase.

14. The computer readable medium as claimed in claim 13, wherein the computer program enables the second recipe phase to be embodied as a summing phase.

15. The computer readable medium as claimed in claim 13, wherein the computer program enables the second recipe phase to be embodied as an incrementing phase.

16. A programming unit incorporating a computer program which, when run on a programming unit operatively connected to a programmable controller, controls a batch process recipe having a first recipe phase and a recipe phase step enabling condition, comprising:
executing a function module assigned to the first recipe phase by the programmable controller;
storing a first setpoint value and a first actual value during the first recipe phase;
providing a second setpoint value and a second actual value in a second recipe phase, the second recipe phase following the first recipe phase;
repeating the first and the second recipe phases in accordance with the step enabling condition; and
adopting the second setpoint value as the second actual value during the second recipe phase.

17. The programming unit as claimed in claim 16, wherein the computer program enables the second recipe phase to be embodied as a summing phase.

18. The programming unit as claimed in claim 16, wherein the computer program enables the second recipe phase to be embodied as an incrementing phase.
